(19) United States
(12) Patent Application Publication
(10) Pub. No.: US 2013/0273227 A1
(43) Pub. Date: Oct. 17, 2013

(54) Supplement Bar

(71) Applicant: Steve Hallaby, Bossley Park (AU)

(72) Inventor: Steve Hallaby, Bossley Park (AU)

(21) Appl. No.: 13/862,714

(22) Filed: Apr. 15, 2013

(30) Foreign Application Priority Data
Apr. 13, 2012 (AU) 2012901457

(51) Int. Cl. A23G 9/38

(52) U.S. Cl. CPC A23G 9/38
USPC 426/565

(57) ABSTRACT

An ice-cream bar comprising protein and having improved organoleptic properties is provided, wherein the ice-cream bar is in the form of a wrap style bar and is not attached to a supporting means such as a stick or biscuit base supports. The ice-cream bar comprises 10% to 35% protein by weight.

### RELATIONSHIP TO OTHER APPLICATIONS

The present application claims priority to and the benefit of the following application: Australian Application No: 2012901457; Filing Date: 13 Apr. 2012; Applicant Name: Steve Hallaby.

### GOVERNMENT SUPPORT

None

### FIELD OF THE INVENTION

The present invention relates to a comestible nutritional supplement product and in particular to a nutritional supplement bar. The invention has been developed primarily for use as protein bar and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

There are a vast number of known nutritional supplement bars, particularly protein bars, available in today's market place. Protein supplements are typically unpleasant to taste and the texture gives an unpleasant mouth feel. Products such as protein ice-cream are available as an alternative form of nutritional supplement, in an attempt to make protein supplements somewhat more palatable. Examples of such protein ice-cream are disclosed in EP1342418, WO2007/110181 and US2008/0089990. High protein dessert products such as ice-cream are increasing in popularity as more varieties become commercially available.

Supplements in the form of protein ice-cream are particularly preferable to consume after physical exercise such as a workout in a gym. Protein ice cream is often consumed by active members of gymnasiums, sporting clubs and the like. Thus, protein ice-cream must be conveniently available at venues for purchase and consumption after a workout or similar physical activity. Such venues include gymnasiums, swimming pools and club headquarters. Individual protein ice-creams with a holding means such as a stick or biscuit base, as in ice-cream sandwiches, have become available in recent years and could be sold in such locations. A number of protein ice-cream sandwiches can be found and ordered online, but lack the convenience of being readily and easily available at a local gymnasium.

Further, these protein ice-cream sandwiches still require biscuit base supports, which contribute to unfavourable additional calories, carbohydrates and sugar in the overall finished product. Protein ice-cream available via attachment to a stick holding means still maintains the problem of unpleasant taste and mouth feel and has additional waste in the form of the stick that must be disposed of.

To address the issues associated with the support means for ice-cream bar products, other commercially available ice-cream health bars have been based around a “wrap style” bar with no stick or biscuit base. A “wrap style” bar would be understood in the art as a freestanding bar with no support but for the plastic wrapping that seals the bar, and the packaging would also be used to hold the bar whilst it is being consumed. An example of such a style of bar includes the “Weiss Bar” commonly available in supermarkets and at take-away outlets. These are typically based on a low fat cream and fruit style recipe such as a “strawberry and cream bar” with low fat and low calorie values. However, significant levels of protein have not been included in ice-cream presented in a “wrap” form because of the resulting poor taste and poor organoleptic properties that would result. A significant amount of sugar and carbohydrates would therefore be required to address these issues in a commercially available product. This would be particularly unwanted to a consumer focused on improving fitness and losing weight.

A protein ice-cream bar is required that has no stick or biscuit base and is produced in an individual wrap style ice-cream bar form. A commercially available bar would require a pleasant taste and mouth feel and be conveniently available to be consumed in a gym after a workout or similar.

It is an object of the present invention to overcome or ameliorate at least one of the disadvantages of the prior art, or to provide a useful alternative.

### SUMMARY OF THE INVENTION

According to a first aspect, the invention provides an ice-cream bar comprising protein and having improved organoleptic properties, wherein said ice-cream bar is in the form of a wrap style bar and is not attached to a supporting means such as a stick or biscuit base supports.

According to a second aspect, the invention provides an ice-cream bar comprising protein and having improved organoleptic properties wherein said bar comprises 10% to 35% protein by weight.

According to a third aspect, the invention provides an ice-cream bar comprising protein and having improved organoleptic properties, wherein said ice-cream bar is in the form of a wrap style bar and is not attached to a supporting means such as a stick or biscuit base supports wherein said bar comprises 10% to 35% protein by weight.

In terms of composition, the a preferred embodiment of the ice-cream bar comprises 20% to 31% protein, which equates to 17 g to 27 g of protein in a standard 85 g bar. In another preferred embodiment, the ice-cream bar also preferably comprises less than or equal to 20% sugar with 10 to 35% protein, preferably 20 to 31% protein. Still more preferably, a preferred embodiment contains less than 6% sugar.

Another embodiment of the ice-cream bar of the present invention comprises 10 to 35% protein by weight with less than or equal to 6% sugar by weight. Still more preferably, this embodiment comprises 10 to 20% protein by weight with less than or equal to 6% sugar by weight. A further embodiment of the present ice-cream bar comprises 10 to 35% protein with artificial sweetener and no sugar, preferably 10 to 20% protein by weight with artificial sweetener and no sugar.

The ice-cream bar of the present invention comprises less than or equal to 17% of carbohydrates, which equates to less than 15 g carbohydrates in a standard 85 g bar. In a particularly preferred embodiment, less than 8 g of carbohydrates is used in a standard 85 g bar. Such embodiments comprise 10-35% protein, preferably 20% to 31% protein. The low carbohydrate and sugar components of this bar are preferred by consumers looking to lose weight and reduce body fat, as well as the very high protein content. It has been surprisingly found that the ice-cream can contain such extremely high levels of protein and low levels of sugar and carbohydrates while still providing a pleasant taste and mouth feel to consumers.

A preferred embodiment of the present invention is a “high protein, low carbohydrate” protein ice-cream bar comprising 27% protein and 10% carbohydrate. In another embodiment, “high protein, high carbohydrate” protein ice-cream bar is used comprising a 27% protein and 25% carbohydrate. Other alternatives include gelato protein ice-cream bars comprising 25% protein and 20% carbohydrate, or 31% protein and 31% carbohydrate. Such embodiments are typically in the form of a gelato ice-cream bar. Gelato is understood in the art as a soft ice-cream containing little or no air. However, a protein ice-cream bar of the present invention may also be found in the form of a more traditional ice cream product containing a greater level of aeration.

The ice-cream bar of the present invention can be modified to control protein release as instantaneous or slow release, preferably using whey protein in an instantaneous release formulation or casein protein in a slow release formulation. The ice-cream bar has been designed to be consumed as a meal replacement.

According to a second aspect, the invention provides a method of producing a gelato protein ice-cream bar according to the first aspect comprising the steps of:
dissolving dry ingredients in water to produce a mixture;
pasteurising and homogenising said mixture;
adding flavour and colour to said mixture as appropriate;
churning said mixture to produce said gelato protein ice-cream bar.

According to a third aspect, the invention provides a gelato protein ice-cream bar produced according to the method of the second aspect.

According to a fourth aspect, the invention provides a method of increasing muscle mass of a person comprising the steps of:
performing an exercise routine designed to increase muscle mass of said person performing said routine;
consuming the ice-cream bar according to the first aspect after performing said routine; wherein said routine comprises the repetitious lifting of weights to build a specific muscle or muscle group to thereby promote growth of said muscle.

If a person wishes to increase the muscle mass of a particular muscle group, they would eat a protein ice-cream bar according to the invention following a strenuous workout to immediately provide protein to the muscle group and their body generally. In addition, the protein ice-cream bar of the invention would provide a cool, relaxing snack following the workout.

According to a fifth aspect, the invention provides a method of increasing weight loss of a person comprising the steps of:
consuming the ice-cream bar according to the first aspect;
performing an exercise routine designed to increase weight loss of said person performing said routine, wherein said routine comprises cardiovascular exercises to promote weight loss and said ice-cream bar can be consumed either before or after said routine to function as a low-carbohydrate meal replacement bar.

According to a sixth aspect, the invention provides use of the ice-cream bar according to the first aspect for increasing muscle mass of a person consuming said ice-cream bar.

According to a seventh aspect, the invention provides use of the ice-cream bar according to the first aspect for increasing weight loss of a person consuming said ice-cream bar.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

### BRIEF DESCRIPTION OF THE DRAWINGS

A preferred embodiment of the invention will now be described, by way of example only, with reference to the accompanying drawings in which:

FIG. 1 is a top view of an ice-cream bar according to the invention formed from a protein ice-cream gelato;

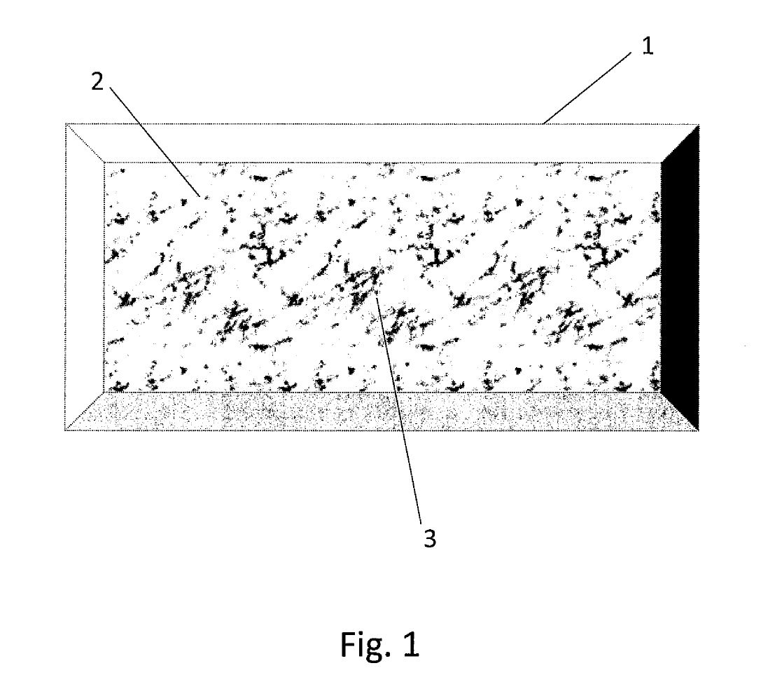

FIG. 2 is a top view of the ice-cream bar of FIG. 1 with a outer wrapper; and

FIG. 3 is a side view of the ice-cream bar of FIG. 1.

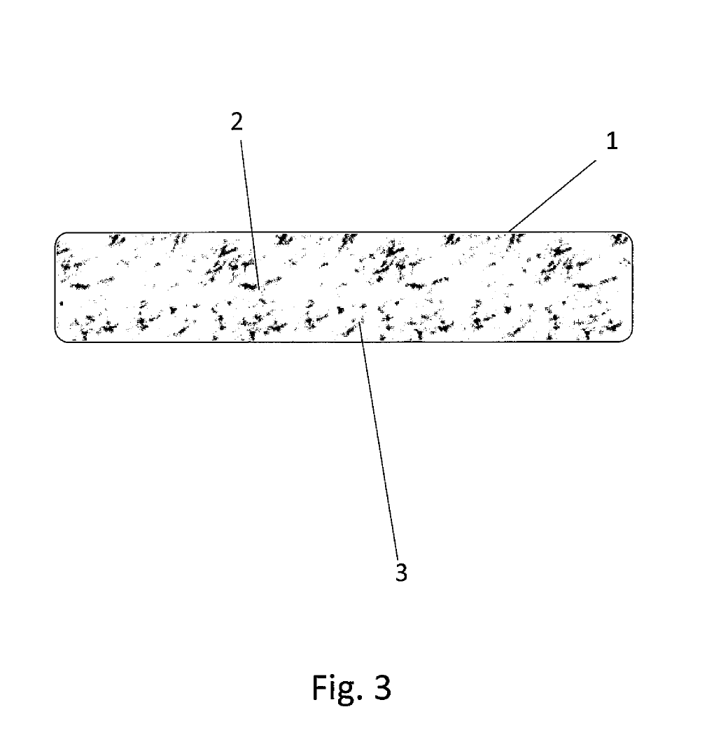

### DETAILED DESCRIPTION OF THE INVENTION

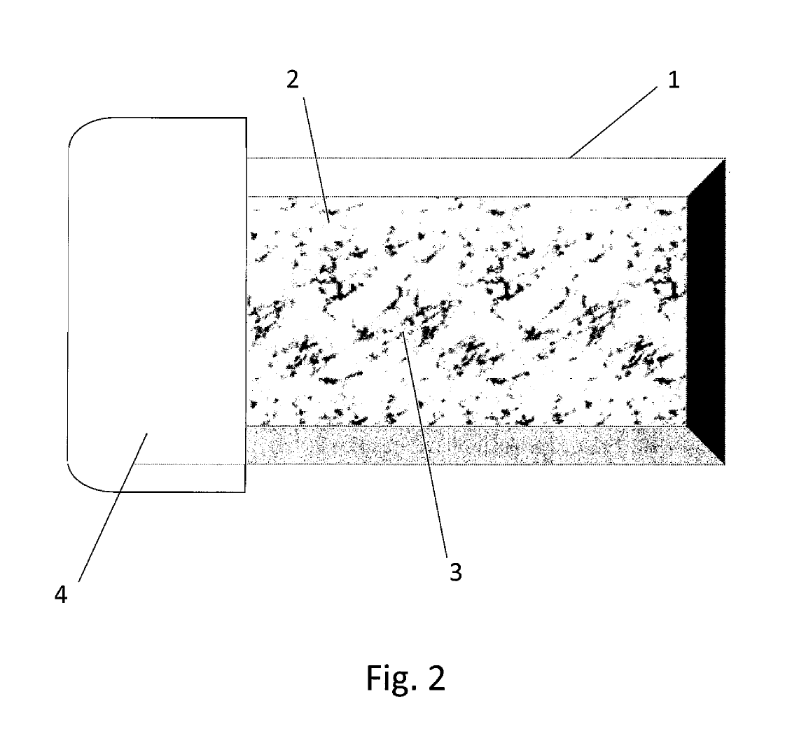

Referring to the drawings, the ice-cream bar 1 is made from protein ice-cream 2 in the form of a gelato 3. The ice-cream bar 1 is in the form of a wrap-style bar requiring no ice-cream stick or biscuit base supports. In FIG. 2, the ice-cream bar 1 is shown with a wrapper 4 at its base. The wrapper 4 is used to encase and store the ice-cream bar 1 before consumption and is removed from the ice-cream when consumed.

The protein ice-cream 2 can use 17 g to 26.4 g of whey protein in a standard 85 g bar. Alternatively, 17 g to 26.4 g of casein protein can be used in a standard 85 g bar. The formulation of the protein ice-cream 2 is controlled using different proteins wherein whey protein is used for instantaneous (quick) release into the bloodstream and casein protein is used for slower protein release into the bloodstream. Less than 20% sugar, preferably less than 6% sugar is used in the protein ice-cream 2, with the sugar often being replaced with another substitute ingredient. The ice-cream bar 1 may also further comprise vitamins and minerals for improved nutritional value.

The protein ice-cream 2 comprises less than or equal to 17% carbohydrates (less than 15 g in an 85 g bar). In a particularly preferred embodiment, 8 g of carbohydrates are used in a standard 85 g bar. Carbohydrates are typically considered as a common source of energy in living organisms. However, it should be noted that no carbohydrate is an essential nutrient in humans. It is theoretically possible for the body to obtain sufficient energy from protein and fat. In the case of protein, this is somewhat misleading as only some amino acids are usable for fuel. It is generally understood that diets high in protein and low in carbohydrates are useful for losing body fat, although it should be noted that there are some medical risks associated with such diets. However, high protein foods are very popular with people attempting to lose weight, reduce body fat and build muscle bulk.

The protein ice-cream 2 is blended as a gelato 3 to form the wrap-style ice-cream bar 1. The present invention is designed as “a frozen protein shake”. A gelato ice-cream is used to combine and blend the components properly, including any extra vitamins and minerals, to provide good mouth feel and taste in spite of the high level of protein. The protein ice-cream bar 1 of the present invention can be used as a meal replacement, as an alternative to a protein shake, protein bar or protein cookie, with improved taste, mouth feel and nutritional benefits, especially suited for consumption after physical activity. As well as acting as a meal replacement, the protein ice-cream bar of the present invention is also designed primarily to assist in muscle growth and to assist in weight loss.

The protein ice-cream bar 1 of the present invention has no stick or biscuit base and is produced in an individual wrap style ice-cream bar form. The wrap-style bar form of the present invention has a pleasant taste and mouth feel and allows for a highly convenient form of ice-cream for purchase and consumption at a gym, for example, after a workout.

### EXAMPLES

Formulations of preferred embodiments of the invention are given below. The percentage weights and specifications of the individual ingredients will naturally vary within the scope of the invention.

TABLE 1
Formulation of High Protein/Low Carbohydrate Ice Cream
Bar - Strawberry Flavour

| | | 1000 g | % |
|---|---|---|---|
| Ingredient Description | w/w | Batch | w/w |
| Water | 50.00 | 500.00 | 50.00 |
| Whey Protein Isolate Instant PIN 101006 | 27.19 | 271.90 | 27.19 |
| Sugar | 8.60 | 86.00 | 8.60 |
| Polydextrose | 7.20 | 72.00 | 7.20 |
| Canola Oil | 4.29 | 42.90 | 4.29 |
| Maltodextrin DE 18 | 2.40 | 24.00 | 2.40 |
| Strawberry Flavour 908311175 | 0.30 | 3.00 | 0.30 |
| Viscarin ME3820 (carrageenan gum) | 0.01 | 0.10 | 0.01 |
| Red Colour (Ponceau 4R) | 0.01 | 0.10 | 0.01 |
| TOTAL | 100.00 | 1000.00 | 100.00 |

TABLE 2
Formulation of High Protein/High Carbohydrate Ice Cream
Bar - Chocolate Flavour

| | | | % |
|---|---|---|---|
| Ingredient Description | w/w | 1000 g Batch | w/w |
| Water | 60.00 | 500.00 | 50.00 |
| Whey Protein Isolate Instant | 27.10 | 225.83 | 22.58 |
| PIN 101006 | | | |
| Sugar | 19.11 | 159.25 | 15.93 |
| Maltodextrin | 6.00 | 50.00 | 5.00 |
| Cocoa Powder (12% fat) | 3.89 | 32.42 | 3.24 |
| Canola Oil | 3.73 | 31.08 | 3.11 |
| Firmtex Starch | 0.16 | 1.33 | 0.13 |
| Viscarin ME3820 (carrageenan gum) | 0.01 | 0.08 | 0.01 |
| TOTAL | 120.00 | 1000.00 | 100.00 |

The principal range of protein ice-cream bars according to the invention will vary according to the examples given above. Tables 1 and 2 outline the formulations for a high protein, low carbohydrate bar and a high protein, high carbohydrate bar generally comprising about 272 g of protein per 1000 g batch. Other formulations include a medium protein, medium carbohydrate bar with approximately 20 to 25% protein and an ultra high protein, ultra-high carbohydrate bar comprising about 31% protein.

A preferred embodiment protein ice-cream bar according to the invention contains less than 6% sugar (low sugar/high protein bar) wherein a 75 g protein ice-cream bar contains 8 g protein (10.7% protein) with less than or equal to 4.5 g sugar. In a further preferred embodiment, the protein ice-cream bar contains minimal to no sugar.

In general, the ratio of protein to carbohydrate in these bars is 1.5:1 for “high protein, low carbohydrate” bars and 1:1 for “high protein, high carbohydrate” bars according to the invention.

A further product range consists of the principal four products outlined above with an additional “+Energy Booster” component. Such a component may include guarana, or the like containing high levels of caffeine or similar energy stimulant.

Another additional product range consists of the principal four products outlined above with an additional “+Fat Stripper” component. Such a component is designed to work with other ingredients in the bar to promote rapid weight loss. Examples of such a component include choline, inositol, betaine, chromium piccolinate and the like. For example, choline works to break down fat and cholesterol in the body and liver, while inositol transports fat out of the body while lowering blood fat and cholesterol. Alternatively, chromium piccolinate is an effective blood sugar regulator which works to promote movement of fat into muscles rather than fat cells.

The ranges of protein ice-cream bars are all produced in flavours typically enjoyed by consumers such as chocolate, strawberry, vanilla and banana.

Protein ice-cream bars according to the invention, such as the formulations given in Tables 1 and 2, are produced according to the following method. The dry ingredients are dissolved in water and the resulting mixture is then pasteurised and homogenised. The pasteurised, homogenised mixture has flavour and colour added as appropriate. The final mixture is then churned to produce the gelato protein ice-cream bar.

Still further, an “Icy” or frozen liquid bar formulation has been developed to be palatable to consumers for a “pre-work out” boost. These frozen liquid bars are similar in form to typical slim lined icy poles that are in a liquid substance prior to storage in the freezer. The formulation for these frozen liquid bars comprises a high carbohydrate content with nil to very low protein content, and is designed as a “Pre-work out+Energy Booster” icy block. These “icy blocks” are designed to be tropical or generally fruit flavoured or similar.

Although the invention has been described with reference to a specific example, it will be appreciated by those skilled in the art that the invention may be embodied in many other forms.

Specific exemplary non-limiting embodiments include the following (please note that although the following embodiments appear in claim-like format, they are not intended to be claims):

(1) An ice-cream bar comprising protein and having improved organoleptic properties wherein said bar comprises from 10% to 35% protein by weight.
(2) The ice-cream bar of claim 1 comprising protein and having improved organoleptic properties, wherein said ice-cream bar is in the form of a wrap style bar and is not attached to a supporting means such as a stick or biscuit base support.
(3) The ice-cream bar of claim 1 comprising protein and having improved organoleptic properties, wherein said ice-cream bar is in the form of a wrap style bar and is not attached to a supporting means such as a stick or biscuit base supports wherein said bar comprises 10% to 35% protein by weight.
(4) The ice-cream bar according to claim 1 wherein said bar comprises 20% to 31% protein by weight and less than 20% sugar by weight.
(5) The ice-cream bar according to claim 4 wherein said bar comprises less than or equal to 6% sugar by weight.
(6) The ice-cream bar according to claim 2 comprising from 10% to 35% protein by weight with either (a) less than or equal to 6% sugar by weight, or (b) with an artificial sweetener and no sugar.
(7) The ice-cream bar according to claim 6 comprising from 10% to 20% protein by weight with either (a) less than or equal to 6% sugar by weight, or (b) with an artificial sweetener and no sugar.
(8) The ice-cream bar according to claim 1 wherein said bar comprises less than or equal to 17% of carbohydrates.
(9) The ice-cream bar according to claim 8 comprising up to 9% carbohydrates.
(10) The ice-cream bar according to claim 2 comprising 27% protein and 10% to 25% carbohydrate.
(11) The ice-cream bar according to claim 2 comprising 25% protein and 20% carbohydrate.
(12) The ice-cream bar according to claim 2 comprising 31% protein and 31% carbohydrate.
(13) The ice-cream bar according to claim 1 wherein said bar is modified to control protein release as instantaneous or slow release wherein said protein is whey protein in an instantaneous release formulation, and said protein is a casein protein in a slow release formulation.
(14) The ice-cream bar according to claim 1 wherein said ice-cream bar is a gelato ice-cream bar.
(15) A method of producing a gelato protein ice-cream bar according to claim 1 comprising the steps of:
dissolving dry ingredients in water to produce a mixture;
pasteurising and homogenising said mixture;
adding flavour and colour to said mixture as appropriate;
churning said mixture to produce said gelato protein ice-cream bar.
   (16) A gelato protein ice-cream bar produced according to the method of claim 15.
   (17) A method of increasing muscle mass of a person comprising the steps of:
performing an exercise routine designed to increase muscle mass of said person performing said routine;
consuming the ice-cream bar according to claim 1 after performing said routine; wherein said routine comprises the repetitious lifting of weights to build a specific muscle or muscle group to thereby promote growth of said muscle.
   (18) A method of increasing weight loss of a person comprising the steps of:
consuming the ice-cream bar according to claim 1;
performing an exercise routine designed to increase weight loss of said person performing said routine, wherein said routine comprises cardiovascular exercises to promote weight loss and said ice-cream bar can be consumed either before or after said routine to function as a low-carbohydrate meal replacement bar.
   (19) Use of the ice-cream bar according to claim 1 for increasing muscle mass of a person consuming said ice-cream bar.
   (20) Use of the ice-cream bar according to claim 1 for increasing weight loss of a person consuming said ice-cream bar.

1. An ice-cream bar comprising protein and having improved organoleptic properties wherein said bar comprises from 10% to 35% protein by weight.

2. The ice-cream bar of claim 1 comprising protein and having improved organoleptic properties, wherein said ice-cream bar is in the form of a wrap style bar and is not attached to a supporting means such as a stick or biscuit base support.

3. The ice-cream bar of claim 1 comprising protein and having improved organoleptic properties, wherein said ice-cream bar is in the form of a wrap style bar and is not attached to a supporting means such as a stick or biscuit base supports wherein said bar comprises 10% to 35% protein by weight.

4. The ice-cream bar according to claim 1 wherein said bar comprises 20% to 31% protein by weight and less than 20% sugar by weight.

5. The ice-cream bar according to claim 4 wherein said bar comprises less than or equal to 6% sugar by weight.

6. The ice-cream bar according to claim 2 comprising from 10% to 35% protein by weight with either (a) less than or equal to 6% sugar by weight, or (b) with an artificial sweetener and no sugar.

7. The ice-cream bar according to claim 6 comprising from 10% to 20% protein by weight with either (a) less than or equal to 6% sugar by weight, or (b) with an artificial sweetener and no sugar.

8. The ice-cream bar according to claim 1 wherein said bar comprises less than or equal to 17% of carbohydrates.

9. The ice-cream bar according to claim 8 comprising up to 9% carbohydrates.

10. The ice-cream bar according to claim 2 comprising 27% protein and 10% to 25% carbohydrate.

11. The ice-cream bar according to claim 2 comprising 25% protein and 20% carbohydrate.

12. The ice-cream bar according to claim 2 comprising 31% protein and 31% carbohydrate.

13. The ice-cream bar according to claim 1 wherein said bar is modified to control protein release as instantaneous or slow release wherein said protein is whey protein in an instantaneous release formulation, and said protein is a casein protein in a slow release formulation.

14. The ice-cream bar according to claim 1 wherein said ice-cream bar is a gelato ice-cream bar.

15. A method of producing a gelato protein ice-cream bar according to claim 1 comprising the steps of:
dissolving dry ingredients in water to produce a mixture;
pasteurising and homogenising said mixture;
adding flavour and colour to said mixture as appropriate;
churning said mixture to produce said gelato protein ice-cream bar.
